(19) United States
(12) Patent Application Publication
(10) Pub. No.: US 2013/0034021 A1
(43) Pub. Date: Feb. 7, 2013

(54) AUTOMATED NETWORK CONFIGURATION IN A DYNAMIC VIRTUAL ENVIRONMENT

(71) Applicants: Ritesh K. Jaiswal, Pune (IN); Akihiko Kuroda, Cary, NC (US); Leon P. Prissel, Rochester, MN (US); Carolyne R. Sealy, Morrisville, NC (US); Esha Seth, Uttar Pradesh (IN)

(72) Inventors: Ritesh K. Jaiswal, Pune (IN); Akihiko Kuroda, Cary, NC (US); Leon P. Prissel, Rochester, MN (US); Carolyne R. Sealy, Morrisville, NC (US); Esha Seth, Uttar Pradesh (IN)

(73) Assignee: INTERNATIONAL BUSINESS MACHINES CORPORATION, Armonk, NY (US)

(21) Appl. No.: 13/541,467

(22) Filed: Jul. 3, 2012

Related U.S. Application Data
(63) Continuation of application No. 13/198,861, filed on Aug. 5, 2011.

(51) Int. Cl. H04L 12/56; H04L 12/28

(52) U.S. Cl. 370/255; 370/401; 370/254

(57) ABSTRACT

In a computer-implemented method, a port profile is associated with a virtual machine that requires a VLAN connection to an external network through an edge port. The port profile includes a VLAN identification associated with the VLAN connection and an edge port identification associated with the edge port. The method further comprises deploying the virtual machine to a target physical server, wherein both the target physical server is in communication with a network switch comprising the edge port. After deploying the virtual machine to the target physical server, the virtual machine is automatically provided with a VLAN connection to the external network in accordance with the port profile associated with the virtual machine. Similarly, a port profile may be associated with a virtual machine as it is created and deployed to a server, wherein the VLAN connection is configured according to the associated port profile.

### CROSS-REFERENCE TO RELATED APPLICATIONS

This application is a continuation of co-pending U.S. patent application Ser. No. 13/198,861, filed on Aug. 5, 2011.

BACKGROUND

1. Field of the Invention

The present invention relates to the management of virtual machines. More specifically, the present invention relates to the configuration of network ports that are used by virtual machines.

2. Background of the Related Art

In a cloud computing environment, a user is assigned a virtual machine, sometimes also referred to as a virtual server, somewhere in the computing cloud. The virtual machine provides the software operating system and has access to physical resources, such as input/output bandwidth, processing power and memory capacity, to support the user's application. Provisioning software manages and allocates virtual machines among the available computer nodes in the cloud. Because each virtual machine runs independent of other virtual machines, multiple operating system environments can co-exist on the same physical computer in complete isolation from each other.

Each virtual machine runs on a hypervisor and typically needs the ability to communicate with other virtual machines and/or communicate over a network. A virtual switch is implemented in the hypervisor and provides the virtual machine with communication to a physical switch. When physical servers that are connected to different networks are consolidated on a hypervisor, their networks are isolated by using a virtual local area network (VLAN), such as that described by IEEE standard 802.2Q, in the virtual switches and in the physical switches. The proper configuration of the virtual switches and physical switches are required to provide the right connectivity and isolation to the proper virtual machines.

However, virtual machines are created and destroyed more often than physical servers, and virtual machines may be moved from one hypervisor to another hypervisor to improve performance and resource utilization. Therefore, it is usually necessary to manually modify the network configuration (especially a VLAN configuration) when a virtual machine is created, destroyed, or moved/migrated. Specifically, providing network connectivity for a VLAN to a newly created or migrated virtual machine requires the configuration of each port that is part of the VLAN. Thus, all the virtual switches in the domain need to be configured with the right VLAN identification in the right port and physical connectivity to the outside network needs to be maintained if required.

### BRIEF SUMMARY

One embodiment of the present invention provides a computer-implemented method, comprising associating a port profile with a virtual machine that requires a VLAN connection to an external network through an edge port, wherein the port profile includes a VLAN identification associated with the VLAN connection and an edge port identification associated with the edge port. The method further comprises migrating the virtual machine from a first physical server to a second physical server, wherein both the first and second physical servers are in communication with a network switch comprising the edge port. After migrating the virtual machine to the second physical server, the virtual machine is automatically provided with a VLAN connection to the external network in accordance with the port profile associated with the virtual machine.

### BRIEF DESCRIPTION OF THE SEVERAL VIEWS OF THE DRAWINGS

FIG. 1 is a diagram of a cloud computing node according to one or more embodiment of the present invention.

FIG. 2 is a diagram of a cloud computing environment according to one or more embodiment of the present invention.

FIG. 3 is a diagram depicting abstraction model layers according to one or more embodiment of the present invention.

FIG. 4 is a diagram of an exemplary computing node that may be utilized according to one or more embodiments of the present invention.

FIG. 5 is a diagram of an exemplary blade chassis that may be utilized according to one or more embodiments of the present invention.

FIG. 6 is a diagram of the Network System Pool Domain.

FIG. 7 is a diagram of the Network System Pool Domain illustrating how a new virtual machine may be deployed.

FIG. 8 is a diagram of the Network System Pool Domain illustrating how a virtual machine may be migrated from one server to another.

FIG. 9 is a flowchart of a method for Virtual System migration.

### DETAILED DESCRIPTION

One embodiment of the present invention provides a computer-implemented method, comprising associating a port profile with a virtual machine that requires a virtual local area network (VLAN) connection to an external network through an edge port, wherein the port profile includes a VLAN identification (VLAN ID) associated with the VLAN connection and an edge port identification associated with the edge port. The method further comprises migrating the virtual machine from a first physical server to a second physical server, wherein both the first and second physical servers are in communication with a network switch comprising the edge port. After migrating the virtual machine to the second physical server, the virtual machine is automatically provided with a VLAN connection to the external network in accordance with the port profile associated with the virtual machine.

The steps that are preferably involved in automatically providing a VLAN connection after migration of the virtual machine include: (1) find the path from the target system to one of the network components configured for the connection, (2) calculate the necessary configuration changes for the network components in the path to establish the connection, (3) issue configuration instructions to each component, including the network switch and hypervisor, (4) instruct the hypervisor to move the virtual system from the source system to the target system, (5) find the path from the source system used only by the migrating virtual system, (6) calculate the necessary configuration changes to remove the unnecessary connection, and (7) issue configuration instructions to each component, including the network switch and hypervisor. These steps are preferably carried out the system management software, such as the IBM Systems Director Network Control running on a remote management node, which has access to Network System Pool Domain definitions and data stored in a database. The management software may rely upon this data in the performance of steps 1, 2, 5, and 6, above.

To configure the VLAN connection, the method identifies the physical/link connections, virtual switches, VLAN identifications and ports that are associated with the virtual switches in the defined domain. Some of this data is static and some is dynamic. For example, information about the physical components and physical connections between these components is static, and the configuration settings of the switches and hypervisor as well as information about the virtual system and virtual switches is dynamic data. However, this information is stored in the port profile in response to retrieving this data. When a virtual network interface controller (NIC) is created or modified, the port of the physical switch to which it would be connected/is connected needs to be known. A virtual NIC is a part of the virtual system and is connected to a virtual switch port.

The step of automatically providing the virtual machine with a VLAN connection to the external network in accordance with the port profile associated with the virtual machine, may further include automatically configuring a virtual switch on the second physical server in accordance with the port profile and automatically configuring the ports necessary to provide communication between the virtual switch and the edge port. Configuring a virtual switch involves creating a virtual switch port, setting the port attributes to include the VLAN ID and connecting the virtual switch port to the virtual NIC of the virtual system. This can be done by accessing the hypervisor unique management application programming interface (API). Configuring the virtual switch may include automatically applying a media access controller (MAC) address to the virtual switch. Where a virtual machine has been migrated, the MAC address is preferably the same MAC address that the virtual machine had prior to migration. The MAC address may be stored in the port profile for use with the virtual machine regardless of the particular server on which the virtual machine is running. Configuring an edge port to support a VLAN is basically the same as configuring an internal port to support the VLAN, except that the access control function of an edge port is preferably configured to prevent unnecessary data coming into the Network System Pool.

The port profile may include a data link layer (“layer 2”) profile in accordance with the Open Systems Interconnection model (OSI model). The OSI model sub-divides a communications system into logical layers that handle similar communication functions and provide services to an upper layer while receiving services from a lower layer. The OSI model includes the following layers: (1) physical layer, (2) data link layer, (3) network layer, (4) transport layer, (5) session layer, (6) presentation layer, and (7) application layer. It is the data link layer that is concerned with the interactions of multiple devices with a shared medium and provides the functional and procedural means to transfer data between network entities. The data link layer profile would typically include the VLAN ID, access control list (ACL), network priority, and data date limit.

In another embodiment, the user may be presented with a list of predefined port attributes that are user-selectable for providing a new virtual machine with a network connection. In response to a user initiating the setup of a port profile for a new virtual machine, a user interface may display the list of predefined port attributes. In one alternative, the user interface prevents the use of port attributes that are not on the list of predefined port attributes. In this manner, a network administrator can ensure that the system is secure from other systems in the L2 domain.

It should be understood that although this disclosure is applicable to cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

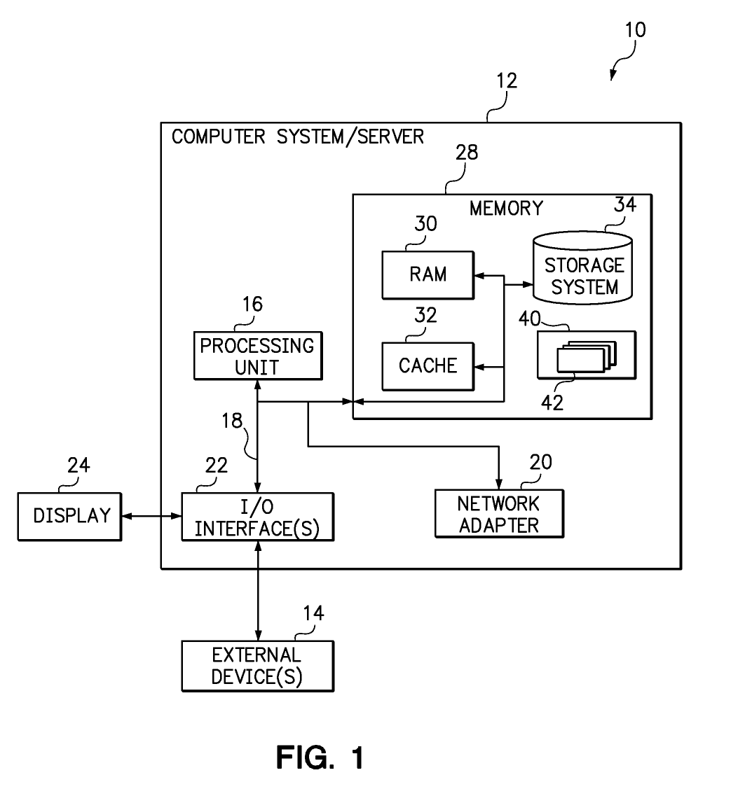

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

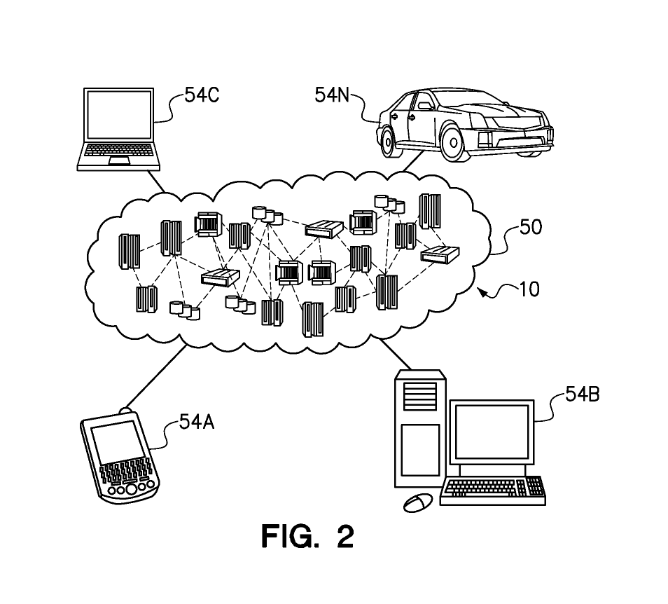

Referring now to FIG. 2, an illustrative cloud computing environment 50 is depicted. As shown, the cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

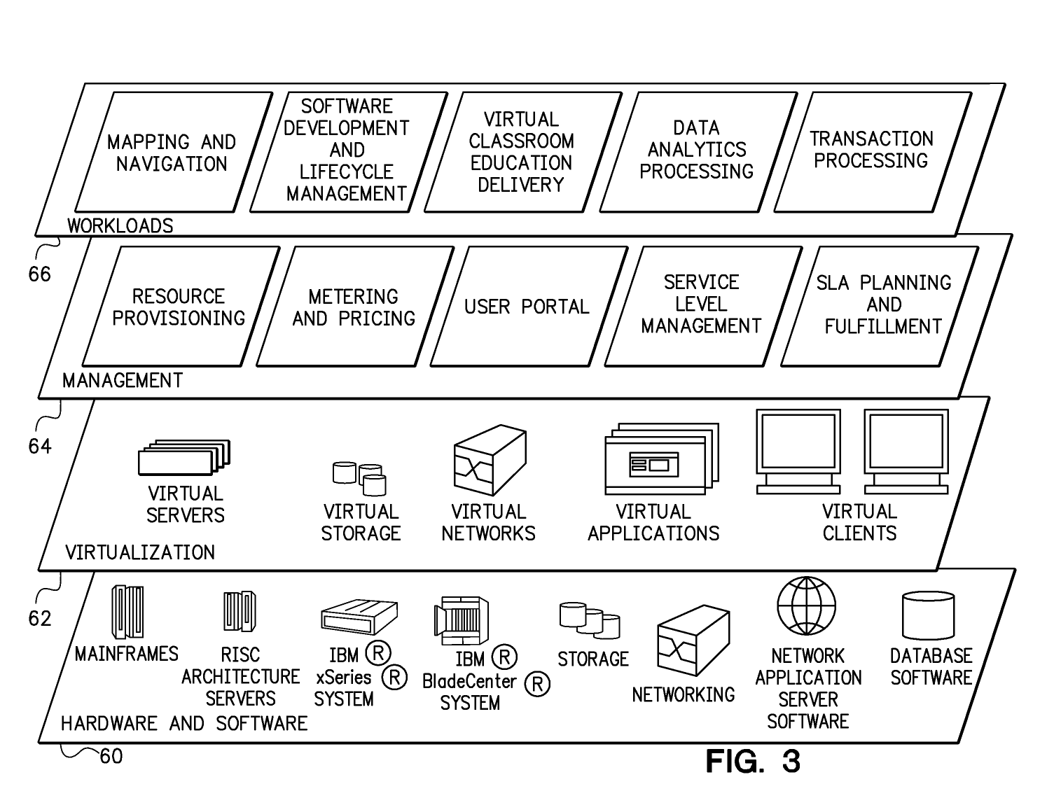

Referring now to FIG. 3, a set of functional abstraction layers provided by cloud computing environment 50 (Shown in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

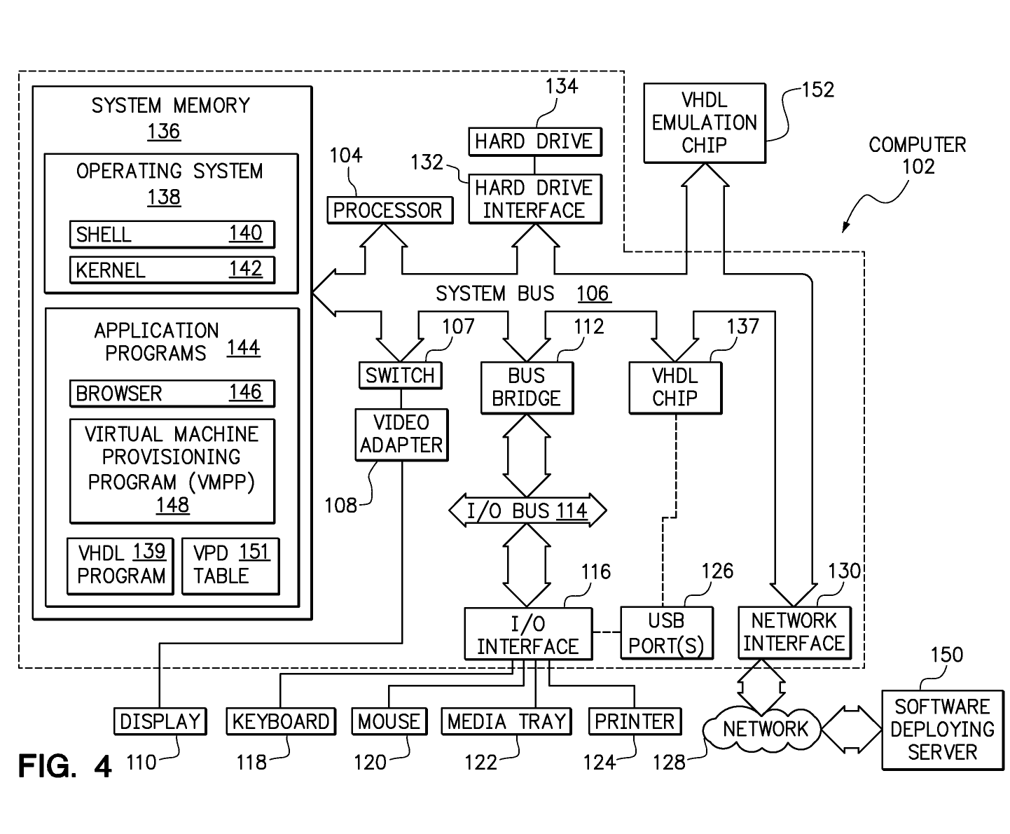

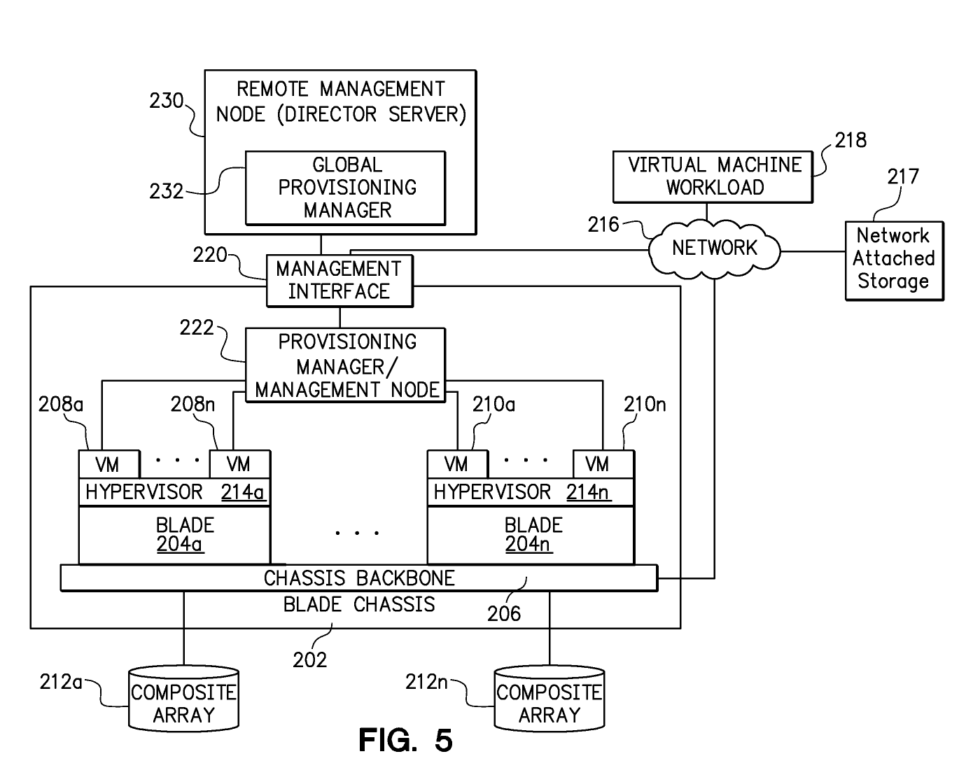

FIG. 4 depicts an exemplary computing node (or simply “computer”) 102 that may be utilized in accordance with one or more embodiments of the present invention. Note that some or all of the exemplary architecture, including both depicted hardware and software, shown for and within computer 102 may be utilized by the software deploying server 150, as well as the provisioning manager/management node 222 and the server blades 204a-n shown in FIG. 5. Note that while the server blades described in the present disclosure are described and depicted in exemplary manner as server blades in a blade chassis, some or all of the computers described herein may be stand-alone computers, servers, or other integrated or stand-alone computing devices. Thus, the terms “blade,” “server blade,” “computer,” and “server” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102′s operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of computer 102 (as well as the system memory of the software deploying server 150) also include a virtual machine provisioning program (VMPP) 148. VMPP 148 includes code for implementing the processes described below, including those described in FIGS. 2-8. VMPP 148 is able to communicate with a vital product data (VPD) table 151, which provides required VPD data described below. In one embodiment, the computer 102 is able to download VMPP 148 from software deploying server 150, including in an on-demand basis. Note further that, in one embodiment of the present invention, software deploying server 150 performs all of the functions associated with the present invention (including execution of VMPP 148), thus freeing computer 102 from having to use its own internal computing resources to execute VMPP 148.

Also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes the VHDL program 139 to configure the VHDL chip 137, which may be an FPGA, ASIC, or the like.

In another embodiment of the present invention, execution of instructions from VMPP 148 results in a utilization of VHDL program 139 to program a VHDL emulation chip 151. VHDL emulation chip 151 may incorporate a similar architecture as described above for VHDL chip 137. Once VMPP 148 and VHDL program 139 program VHDL emulation chip 151, VHDL emulation chip 151 performs, as hardware, some or all functions described by one or more executions of some or all of the instructions found in VMPP 148. That is, the VHDL emulation chip 151 is a hardware emulation of some or all of the software instructions found in VMPP 148. In one embodiment, VHDL emulation chip 151 is a programmable read only memory (PROM) that, once burned in accordance with instructions from VMPP 148 and VHDL program 139, is permanently transformed into a new circuitry that performs the functions needed to perform the processes of the present invention.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

A cloud computing environment allows a user workload to be assigned to a virtual machine (VM) somewhere in the computing cloud. This virtual machine provides the software operating system and physical resources such as processing power and memory to support the user's application workload. The present disclosure describes methods for placing virtual machines among physical servers based on an image content classification or the amount of identical memory pages between two virtual machines.

FIG. 5 depicts an exemplary blade chassis that may be utilized in accordance with one or more embodiments of the present invention. The exemplary blade chassis 202 may operate in a “cloud” environment to provide a pool of resources. Blade chassis 202 comprises a plurality of blades 204a-n (where “a-n” indicates an integer number of blades) coupled to a chassis backbone 206. Each blade supports one or more virtual machines (VMs). As known to those skilled in the art of computers, a VM is a software implementation (emulation) of a physical computer. A single hardware computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As depicted in FIG. 5, blade 204a supports VMs 208a-n (where “a-n” indicates an integer number of VMs), and blade 204n supports VMs 210a-n (wherein “a-n” indicates an integer number of VMs). Blades 204a-n are coupled to a storage device 212 that provides a hypervisor 214, guest operating systems, and applications for users (not shown). Provisioning software from the storage device 212 allocates boot storage within the storage device 212 to contain the maximum number of guest operating systems, and associates applications based on the total amount of storage (such as that found within storage device 212) within the cloud. For example, support of one guest operating system and its associated applications may require 1 GByte of physical memory storage within storage device 212 to store the application, and another 1 GByte of memory space within storage device 212 to execute that application. If the total amount of memory storage within a physical server, such as boot storage device 212, is 64 GB, the provisioning software assumes that the physical server can support 32 virtual machines. This application can be located remotely in the network 216 and transmitted from the network attached storage 217 to the storage device 212 over the network. The global provisioning manager 232 running on the remote management node (Director Server) 230 performs this task. In this embodiment, the computer hardware characteristics are communicated from the VPD 151 to the VMPP 148 (See FIG. 4). The VMPP 148 communicates the computer physical characteristics to the blade chassis provisioning manager 222, to the management interface 220, and to the global provisioning manager 232 running on the remote management node (Director Server) 230.

Note that chassis backbone 206 is also coupled to a network 216, which may be a public network (e.g., the Internet), a private network (e.g., a virtual private network or an actual internal hardware network), etc. Network 216 permits a virtual machine workload 218 to be communicated to a management interface 220 of the blade chassis 202. This virtual machine workload 218 is a software task whose execution, on any of the VMs within the blade chassis 202, is to request and coordinate deployment of workload resources with the management interface 220. The management interface 220 then transmits this workload request to a provisioning manager/management node 222, which is hardware and/or software logic capable of configuring VMs within the blade chassis 202 to execute the requested software task. In essence the virtual machine workload 218 manages the overall provisioning of VMs by communicating with the blade chassis management interface 220 and provisioning management node 222. Then this request is further communicated to the VMPP 148 in the computer system. Note that the blade chassis 202 is an exemplary computer environment in which the presently disclosed methods can operate. The scope of the presently disclosed system should not be limited to a blade chassis, however. That is, the presently disclosed methods can also be used in any computer environment that utilizes some type of workload management or resource provisioning, as described herein. Thus, the terms “blade chassis,” “computer chassis,” and “computer environment” are used interchangeably to describe a computer system that manages multiple computers/blades/servers.

### EXAMPLE

A Network System Pool may be established to enable automatic end-to-end traversal/configuration of a VLAN from a VNIC of a VM to the edge port connecting to external network may be implemented in a defined subset of the Layer 2 broadcast domain. As described herein, the Network System Pool enables network configuration tasks to be simplified and automated, so day-to-day virtual server deployment and mobility operations do not require manual configuration or assistance from the network team to ensure physical network server connectivity. Specifically, the automatic VLAN configuration may include automatic MAC address migration, automatic Layer 2 profile migration (VLANs, access control lists (ACLs), Quality of Service), and automatic end-to-end port configuration.

A user interface may be provided to enable users to create a port profile for a virtual machine, and may only let users select from a list of pre-defined port attributes for connections for new virtual machines. In this way, a network administrator can assure that the Network System Pool is secure from other systems in the Layer 2 domain.

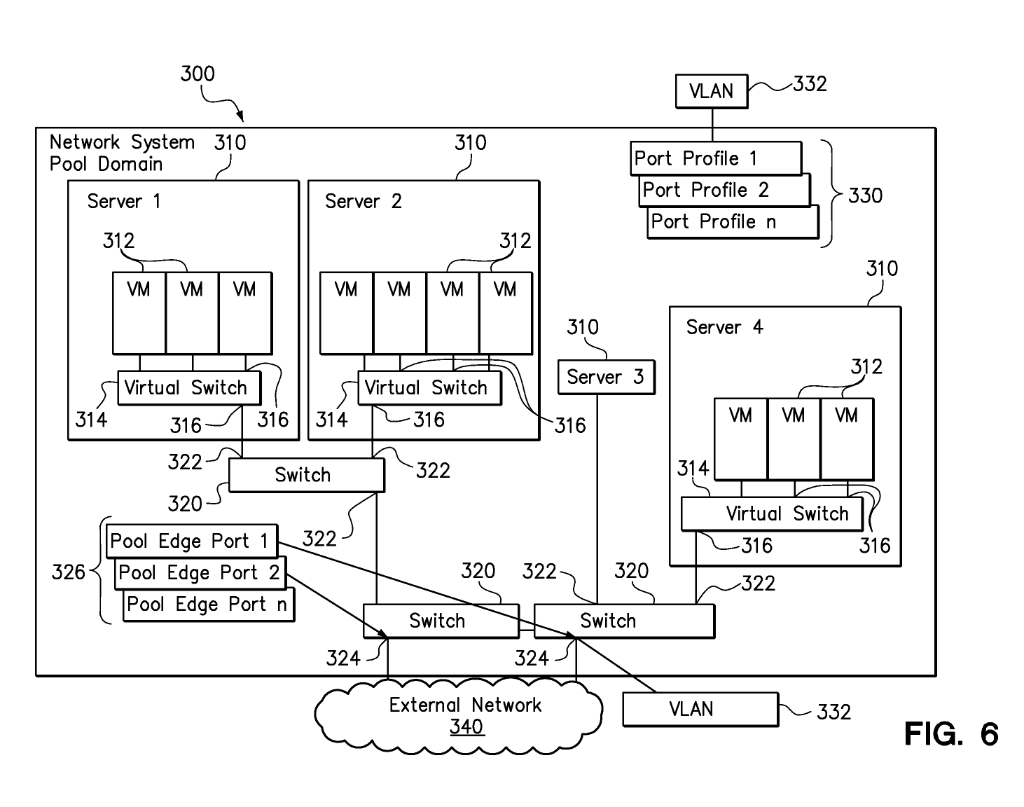

FIG. 6 is a diagram of the Network System Pool Domain 300. The Network System Pool Domain may extend to a subset of hypervisor systems on the servers 310 in a much larger system and a subset of physical network switches 320 in a much larger Layer 2 broadcast domain. Any number of port profiles 330 may be provided, where each port profile includes a set of network attributes for a network connection including a VLAN identification 332.

Each of the physical server 310 in the Network System Pool Domain 300 is coupled to a physical switch 320 to enable a virtual machine 312 to communicate with virtual machines on other physical servers within the Network System Pool Domain or with other entities over the external network 340. Connections in and out of the physical switches 320 are ports 322 that must be appropriately configured. Within the Network System Pool 300, at least one network port of at least one of the physical switches 320 is connected to the external network 340 (i.e., the network outside of the network system pool) and is referred to as a “Domain Edge Port” (see edge ports 324). The edge ports 324 are described by Domain Edge Port definitions 326.

Each physical server 310 may run one or more virtual machines 312 on top of a hypervisor (not shown). Virtual switches 314 may have their own ports 316 and may be configured to provide communication between the virtual machines 312 and a port 322 of a physical switch 320.

Before a virtual machine 312 can be created or moved, it is necessary to define a network system pool domain 300, define port profiles 330 for the network connection that virtual machines will use within the domain, and define domain edge ports 324 and their attributes for the port that connects to the outside of the domain. Defining these entities involves listing the components and attributes and storing the list in a database where the information is used by the management software to find communication paths and calculate necessary configuration changes for the components.

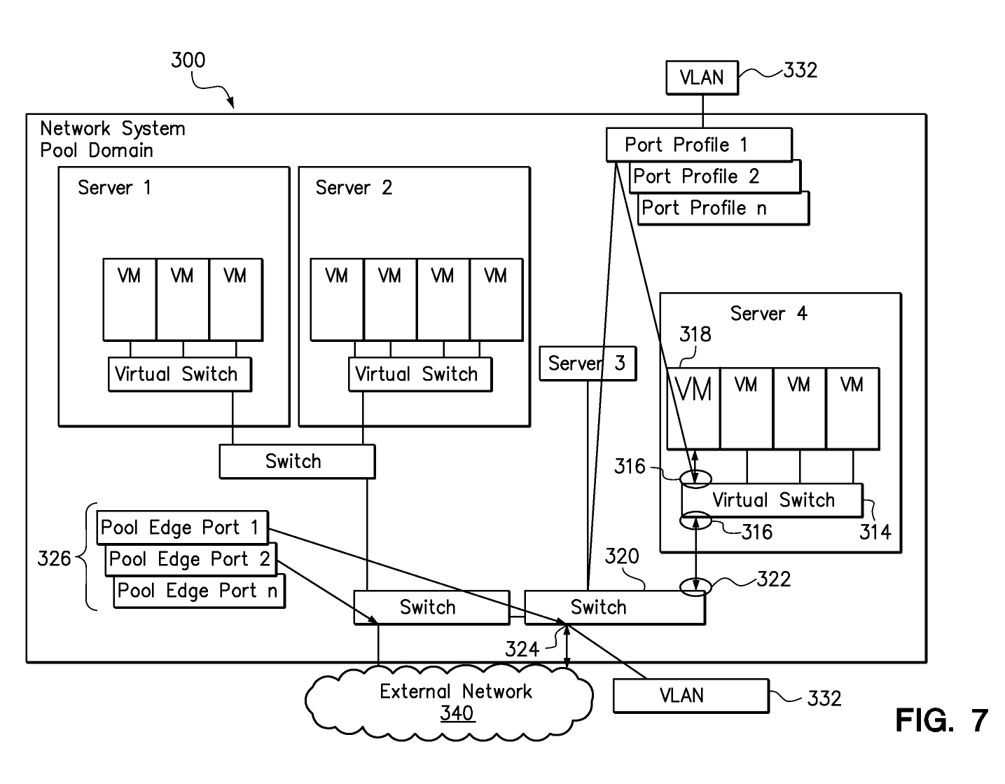

FIG. 7 is a diagram of the Network System Pool Domain 300 illustrating how a new virtual machine 318 may be deployed. Specifically, the new virtual machine 318 is deployed to Server 4. Port Profile 1 is selected during deployment to be associated with the virtual machine 318 and defines the virtual machine's network connection needs. The connection to the virtual switch 314 is configured based on the information in Port Profile 1. The port profile further identifies a Domain Edge Port 324 and the corresponding Pool Edge Port 1 definition 326 is checked to determine the required connection path. Accordingly, the ports 316, 322 along that connection path between the virtual switch 314 and the edge port 324 are then configured automatically. The VLAN identification 332 that is in Port Profile 1 is provided to the edge port 324 as part of the VLAN configuration.

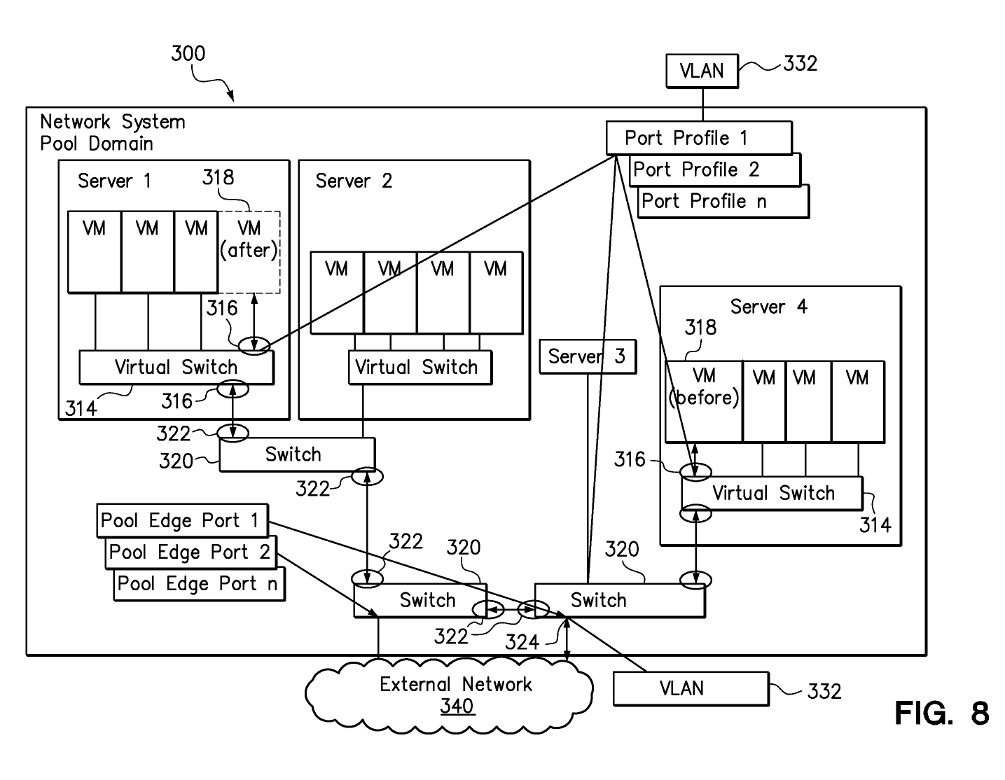

FIG. 8 is a diagram of the Network System Pool Domain 300 illustrating how the virtual machine 318 may be migrated from one server to another. As shown, the virtual machine 318 created in reference to FIG. 7 is to be migrated from Server 4 to Server 1. In conjunction with that migration, the Port Profile 1 that was previously associated with the virtual machine 318, is used as the basis for configuring a connection between the virtual machine (after migration; now on Server 1) to the Domain Edge Port 324. Configuring the connection for the virtual machine 318 (in the new location on Server 1) may include configuring ports of the virtual switch 314 coupled to the virtual machine 318 on Server 1, configuring a Domain Edge Port 324, and configuring internal ports 322 of the physical switches 320 along an identified path between the virtual switch 314 and the edge port 324. Accordingly, when a virtual machine is moved from one hypervisor to another within the network system pool 300, the network elements in the network system pool domain are automatically reconfigured to provide the same connectivity to the virtual server in a different hypervisor and cleans up unnecessary configuration.

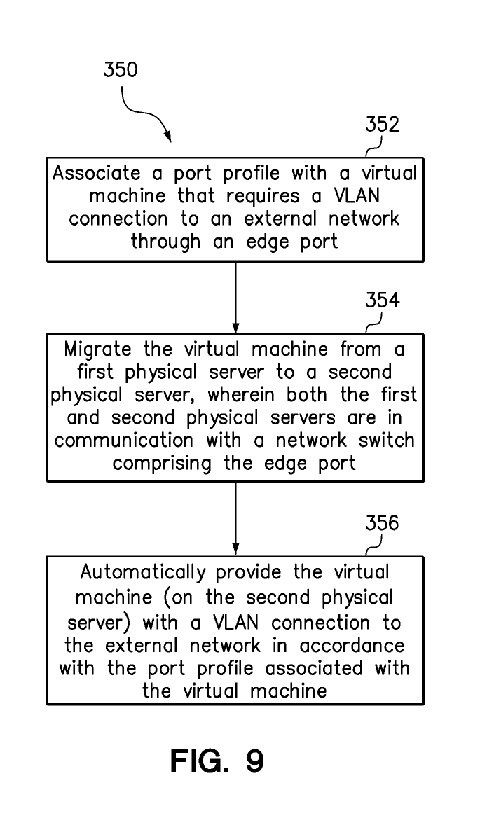

FIG. 9 is a diagram of a method 350 according to one embodiment of the invention. In step 352, the method associates a port profile with a virtual machine that requires a VLAN connection to an external network through an edge port, wherein the port profile includes a VLAN identification associated with the VLAN connection and an edge port identification associated with the edge port. In step 354, the virtual machine is migrated from a first physical server to a second physical server, wherein both the first and second physical servers are in communication with a network switch comprising the edge port. After migrating the virtual machine to the second physical server in step 354, step 356 automatically provides the virtual machine with a VLAN connection to the external network in accordance with the port profile associated with the virtual machine. The method may include additional steps as described in this disclosure.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
associating a port profile with a virtual machine that requires a VLAN connection to an external network through an edge port, wherein the port profile includes a VLAN identification associated with the VLAN connection and an edge port identification associated with the edge port;
deploying the virtual machine to a target physical server, wherein the target physical server is in communication with a network switch comprising the edge port; and
after deploying the virtual machine to the target physical server, automatically providing the virtual machine with a VLAN connection to the external network in accordance with the port profile associated with the virtual machine.

2. The computer-implemented method of claim 1, wherein the virtual machine is deployed to the target physical server during creation of the virtual machine.

3. The computer-implemented method of claim 1, wherein the virtual machine is deployed to the target physical server as a result of migrating the virtual machine from a source physical server.

4. The computer-implemented method of claim 3, wherein both the target physical server and the source physical server are in communication with the same network switch comprising the edge port.

5. The computer-implemented method of claim 3, further comprising:
deconfiguring the VLAN connection to the source physical server.

6. The computer-implemented method of claim 1, wherein automatically providing the virtual machine with a VLAN connection to the external network in accordance with the port profile associated with the virtual machine, includes automatically configuring a virtual switch on the target physical server in accordance with the port profile and automatically configuring ports necessary to provide communication between the virtual switch and the edge port.

7. The computer-implemented method of claim 6, further comprising:
automatically applying a media access controller (MAC) address to the virtual switch.

8. The computer-implemented method of claim 6, wherein the port profile includes a Layer 2 profile.

9. The computer-implemented method of claim 6, further comprising:
providing a list of predefined port attributes that are user-selectable for providing a new virtual machine with a network connection.

10. The computer-implemented method of claim 6, further comprising:
preventing the use of port attributes that are not on the list of predefined port attributes.
